(19) United States
(12) Patent Application Publication
(10) Pub. No.: US 2014/0233439 A1
(43) Pub. Date: Aug. 21, 2014

(54) DOWNLINK-UPLINK CONFIGURATION DETERMINATION

(71) Applicants: Wei Hong, Beijing (CN); Haiming Wang, Beijing (CN); Chunyan Gao, Beijing (CN); Jing Han, Beijing (CN)

(72) Inventors: Wei Hong, Beijing (CN); Haiming Wang, Beijing (CN); Chunyan Gao, Beijing (CN); Jing Han, Beijing (CN)

(73) Assignee: Broadcom Corporation, Irvine, CA (US)

(21) Appl. No.: 14/351,705

(22) PCT Filed: Oct. 24, 2011
(86) PCT No.: PCT/CN2011/081174

§ 371 Date: Apr. 14, 2014

(51) Int. Cl. H04L 5/14

(52) U.S. Cl. CPC H04L 5/1438
USPC 370/280

(57) ABSTRACT

Uplink and downlink traffic for a plurality of user equipments UEs in a cell is differentially weighted according to traffic type, and that weighted traffic total is used to select one uplink-downlink configuration for a radio frame from among A>1 possible uplink-downlink configurations. The weighting may use a priority factor or traffic class identifier that corresponds to the traffic type. In one embodiment the configuration selection is autonomous, and may be made to maximize throughput in the cell or to minimize a number of subframes that overlap with neighbor cells. In another embodiment there is a cooperation; one access node selects multiple candidate configurations which its neighbor cells score for their own acceptability and return the score tables to the original access node, who makes the final selection using the neighbors' score tables. Specific examples are in the context of the E-UTRAN/LTE system.

### TECHNICAL FIELD

The exemplary and non-limiting embodiments of this invention relate generally to wireless communication systems, methods, devices and computer programs, and more specifically relate to selecting a configuration for a radio frame which stipulates which subframes are downlink and which are uplink.

### BACKGROUND

The following abbreviations that may be found in the specification and/or the drawing figures are defined as follows:
3GPP third generation partnership project
CA carrier aggregation
CC component carrier
CN core network
DL downlink
eNB node B/base station in an E-UTRAN system
DL downlink
E-UTRAN evolved UTRAN (LTE)
FDD frequency division duplex
HARQ hybrid automatic repeat request
HeNB home eNB
ICI inter-cell interference
LTE-A long term evolution-advanced (of E-UTRAN)
MAC medium access control
OFDM orthogonal frequency division multiplexing
OTAC over the air communication
QCI traffic class identifier
SF subframe
TDD time division duplex
UE user equipment
UL uplink
UTRAN universal terrestrial radio access network

The LTE-Advanced system is expected to be part of 3GPP LTE Rel-11, Allowing for asymmetric UL-DL allocations has been claimed as one benefit of deploying the TDD system in LTE-A. The asymmetric resource allocation in LTE TDD is realized by providing seven different semi-statically configured uplink-downlink configurations, shown at FIG. 1 which is reproduced from table 4.2-2 of 3GPP TR 36.211 v9.1.0 (2010-03). As can be seen, these various allocations can provide between 40% and 90% DL subframes. The current mechanism for adapting the UL/DL allocation is based on changing system information broadcast by the serving cell. However, this mechanism is semi-static and so the allocation at any given time may not match the instantaneous traffic situation, leading to inefficient resource utilization. This inefficiency is most pronounced in cells which have a small number of users since there the overall traffic profile is more prone to change more frequently.

For this reason, the topic of flexible TDD sub-frame configuration had been proposed as one study item in LTE-A release 11. See for example document RP-101265 by Eriksson and ST-Eriksson entitled NEW STUDY ITEM PROPOSAL FOR UL-DL FLEXIBILITY AND INTERFERENCE MANAGEMENT IN LTE TDD and document RP-101241 by CATT entitled NEW STUDY ITEM PROPOSAL: DL-UL INTERFERENCE MANAGEMENT FOR TDD EUTRA (both documents from 3GPP TSG-RAN Meeting #50; Istanbul, Turkey; Dec. 7-10, 2010). The decision was made in March 2011 to explore this concept for LTE-A in more detail. Document R4-113570 by CATT entitled INTERFERENCE STUDY WITH SYSTEM SIMULATION FOR LTE TDD eIMTA (3GPP TSG-RAN Meeting #59AH; Bucharest, Romania; 27 Jun.-1 Jul., 2011) show that significant gains can be achieved from a more dynamic flexibility of the TDD DL/UL configuration, at least for the case of isolated cells (femto cells in that document).

Some challenges remain before such throughput gains can be realized in a practical wireless system. For example, there must be some way to avoid or mitigate DL and UL interference among neighbor cells, there must be some way to keep all the relevant parties (UEs, eNBs) informed of what the DL-UL configuration is to be for any given frame without drastically increasing control signaling overhead, and there must also be a way to map feedback signaling and arrange HARQ timing for a dynamically changing DL-UL radio frame configuration. The above mentioned document R4-113570 concluded that the DL-UL interference among femto cells is quite small but the DL-UL interference among macro cells is large. Embodiments detailed below solve in an efficient manner how to implement a dynamically changeable DL-UL configuration for radio frames.

### SUMMARY

In a first exemplary embodiment of the invention there is an apparatus comprising at least one processor and at least one memory including computer program code. In this embodiment the at least one memory and the computer program code is configured, with the at least one processor, to cause the apparatus at least to: differentially weight downlink and uplink traffic for a plurality of user equipments according to traffic type; and to select an a^{th} uplink-downlink configuration for a radio frame from among A uplink-downlink configurations based on a total of the weighted downlink and uplink traffic. In this embodiment as well as the second and third immediately below, A is an integer greater than one.

In a second exemplary embodiment of the invention there is a method comprising: differentially weighting downlink and uplink traffic for a plurality of user equipments according to traffic type; and selecting an a^{th} uplink-downlink configuration for a radio frame from among A uplink-downlink configurations based on a total of the weighted downlink and uplink traffic.

In a third exemplary embodiment of the invention there is a computer readable memory tangibly storing a computer program that is executable by at least one processor. In this embodiment the computer program comprises: code for differentially weighting downlink and uplink traffic for a plurality of user equipments according to traffic type; and code for selecting an a^{th} uplink-downlink configuration for a radio frame from among A uplink-downlink configurations based on a total of the weighted downlink and uplink traffic.

These and other aspects of the invention are detailed below with particularity.

### BRIEF DESCRIPTION OF THE DRAWINGS

FIG. 1 is a prior art table 4.2-2 of 3GPP TR 36.211 v9.1.0 (2010-03) showing seven different DL-UL configurations for a radio frame in the LTE system.

FIG. 2 is a table adapted from table 6.1.7 of 3GPP TS 23.203 v11.3.0 (2011-09) showing QCI values for various example traffic types and the delay budgets and packet error loss rates for each, with the priority factor column added according to an exemplary embodiment of these teachings.

FIG. 3 is a schematic diagram illustrating three adjacent cells with multiple UEs operating in each and the neighbor eNBs exchanging traffic information to select a DL-UL subframe configuration according to an exemplary embodiment of these teachings.

FIG. 4 is an exemplary information element according to a second embodiment of these teachings by which an access node informs its neighbors of its list of DL-UL configuration candidates for use in its own cell.

FIG. 5 is an exemplary information element according to the second embodiment of these teachings by which neighbor cells inform a requesting access node of their acceptability scoring for the list of candidates provided by the FIG. 4 information element.

FIG. 6 is a logic flow diagram from the perspective of the eNB that illustrates the operation of a method, and a result of execution by an apparatus of a set of computer program instructions embodied on a computer readable memory, in accordance with the exemplary embodiments of this invention.

FIG. 7 is a simplified block diagram of a UE and an eNB which are exemplary electronic devices suitable for use in practicing the exemplary embodiments of the invention.

### DETAILED DESCRIPTION

Beginning from the 3GPP agreed starting point that DL-UL radio frame configuration should be dynamically changeable, to find a proper solution it is incumbent to first state the problem correctly. Given that dynamic DL-UL configuration is to be the end result, one problem statement is how is the LTE-A system to decide the TDD configuration and what are the decision criteria? It may initially appear that the TDD configuration decision can be made based strictly on the balance of traffic in the uplink and the downlink directions. But this leads to an impractical solution, for the relation between traffic and the radio resources to communicate that traffic is more complex; some traffic with high quality of service QoS requirement may need more resources while other traffic with a very low QoS requirement needs fewer resources.

There is also a further consideration. In the LTE-A system there are macro cells (conventionally understood cellular base stations) and what are termed femto cells (such as home eNBs, closed subscriber group cells, or public-use cells with a much smaller geographic reach than the macro cells and under control of a macro cell). If the cell is not an isolated cell (in which a macro cell or a hybrid cell of a macro and a femto cell are examples of non-isolated cells), the DL-to-UL interference can be a serious factor to be considered. For example, changing the TDD configuration for a femto cell may have severe impacts on the neighboring cells (its macro cell or other neighbors), and there may also be different effects for different cells. A practical solution should also consider the impacts on other cells when deciding which TDD configuration is to be used.

To this end exemplary embodiments of these teachings provide that, for at least non-isolated cells such as macro eNBs and hybrid macro/femto eNBs, during operation each eNB decides the UL/DL ratio according to a weighted total UL/DL traffic size. The eNB can obtain the unweighted total UL traffic size from the buffer status reports BSRs that each UE sends uplink. The eNB can obtain the unweighted total DL traffic size from its own DL buffer that it maintains for each UE. All of this buffered data is waiting to be sent UL or DL. There are various ways for the eNB to weight those raw traffic totals, for example the eNB may apply a factor according to each individual traffic's QCI. The different QCIs will have different weight factors which are applied to the individual buffered traffic volumes/sizes to get a weighted traffic load total for both UL and DL.

QCI is a traffic class identifier which is known in the wireless arts, and in fact is defined specifically in 3GPP TS 23.203 as a scalar value that is used as a reference for a specific packet forwarding behavior, such as for example packet loss rate and packet delay budget. FIG. 2 is a table showing maximum packet loss rate and maximum packet delay budgets for various QCI values, and also showing traffic class or type under the “example services” column for the various QCI values. FIG. 2 is taken from table 6.1.7 of 3GPP TS 23.203 v11.3.0 (2011-09). The examples herein use QCI because that traffic identifier is already adopted in the LTE system and so using QCI renders these teachings simpler to adopt into conventional LTE, but other kinds of traffic priority rating, known or newly developed, will also be effective in realizing the advantages of these teachings.

According to a more particular embodiment, once the eNB obtains this weighted total UL/DL traffic size it decides several candidate DL/UL configurations to fit the weighted total UL/DL traffic load ratio. Then there are two embodiments for how one DL-UL configuration is chosen for use in the cell.

A first embodiment may be termed a concentric mechanism by the requesting cell. In this embodiment the TDD configuration is chosen according to a predetermined rule or set of rules. For example, one such rule is to select the DL-UL configuration to maximize the overall UL and DL throughput in the cell. This is best used when the cell is a non-isolated cell. A different rule is to minimize the number of overlapped UL and DL subframes with one or more neighboring cells, in which the number of neighboring cells to consider for avoiding overlap depends on the interference potential between the subject cell and its neighbors. To coordinate this minimization of UL and DL subfrarne overlap the adjacent cells can share their proposed TDD configuration via an X2 interface (or for non-LTE systems some other direct interface between base stations).

A second embodiment may be considered a polling mechanism among neighbor cells. In this embodiment the cell/eNB which collects the UL and DL buffer data volumes for its own UEs and weighs them for priority will as above and select from among all of the A possible configurations (A=7 for conventional LTE as noted above) a few candidate DL-UL configurations that best fit the weighted data. Then the cell shares these selected candidate DL-UL configurations with its neighbor cells, and gets from those neighbor cells their list of candidate DL-UL configurations. This sharing of candidate configurations may be via a newly defined information element, which may be communicated via the direct X2 or similar interface or via a new over-the-air communication protocol. Each cell/eNB then has the list of selected candidate configurations from each of its neighbor cells which the cells score based on the scoring cell's own traffic rules. This score reflects, from the scoring cell's perspective given its own traffic load and interference (and possibly additional considerations), just how acceptable are each of the neighbor cell's candidate configurations. The per-candidate scores (or score tables) are then sent back to the cell which originally sent the candidate list, again using a new information element over the X2 or similar interface or via a new OTAC protocol.

Still further for implementing the polling mechanism embodiment, each eNB after receiving the score tables from neighbor eNBs, will then derive a combined score for each candidate TDD configuration. The eNBs will do this according to a predetermined algorithm which considers the received configuration scores to optimize the system performance. Each eNB will then have its list of candidate TDD configurations, its own weighted DL and UL traffic totals, and the score tables from its neighbor cells which score that same list of candidate configurations. From those inputs the eNB will then decide a final TDD configuration, which the eNB will inform to its neighbor eNBs via the X2 interface or some OTAC protocol.

To this point only the dynamically configurable DL-UL subframe configuration for the cell (and for the neighbor cells) has been decided. In more particular embodiments of these teachings the scheduling of individual UEs' traffic into the DL and UL subframes of a frame using that decided configuration is based on the individual UE's traffic QCI requirements, and possibly also at least the UE's SINR and the ICIC requirements in the cell. For example, the cell-edge UEs are preferred to be scheduled in fixed sub-frame and the cell-center UEs are preferred to be scheduled in flexible sub-frame to avoid severe DL-UL interference, since the cell-edge UEs will be more susceptible to interference to and from neighbor cells. To more efficiently avoid interference the eNB could send a high interference indicator HII to neighbor cells to pre-define the resources used for its cell-edge UEs. HII is an information element defined at section 9.2.18 of 3GPP TR 36.423 v9.2.0 (2010-03) which provides a 2-level report on interference sensitivity per physical resource block.

The above specific examples are best suited for use by non-isolated cells. For isolated cells such as femto eNBs, the femto eNB could simply decide its own DL-UL subframe configuration for itself after weighting the total DL and UL traffic in its own cell according to traffic type/priority as described above for the non/isolated cells. In this case the isolated femto eNB need not poll its neighbor macro cell and the macro cell does not return a score table of the femto eNB's candidate configurations.

Now consider a specific example and how a DL-UL configuration might be chosen on a dynamic basis for UE traffic according to the various implementations detailed above. First consider the eNB assessing the total DL and UL traffic in its own cell using the following variables:
n is the total number of UL traffic;
m is the total number of DL traffic;
l is the total number of UEs;
UL_buffer_size_{UE(x), traffic(i)} is the buffer size of UL traffic(i) of UE(x);
DL_buffer_size_{UE(x), traffic(i)} is the buffer size of DL traffic(i) of UE(x), where iε(l . . . n) and xε(1 . . . l); and
UL_priority_factor_{traffic(i)} is the priority factor of UL traffic(i) and DL_priarity_factor_{traffic(i)} is the priority factor of DL traffic(i), where UL_priority_factor_{traffic(i)}) and DL_priority_factor_{traffic(i)}ε(a, b, c, d, e, f, g, h).

The algorithm to weight the total DL and UL traffic in a given cell may be expressed as:

$$\frac{{\sum }_{x = 1}^{l} {\sum }_{i = 1}^{n} UL\_buffer {\_size}_{UE ( x ) , traffic ( i )} * UL\_priority {\_factor}_{traffic ( i )}}{\underline{{\sum }_{x = 1}^{l} {\sum }_{i = 1}^{m} DL\_buffer {\_size}_{UE ( x ) , traffic ( i )} * DL\_priority {\_factor}_{traffic ( i )}}}$$

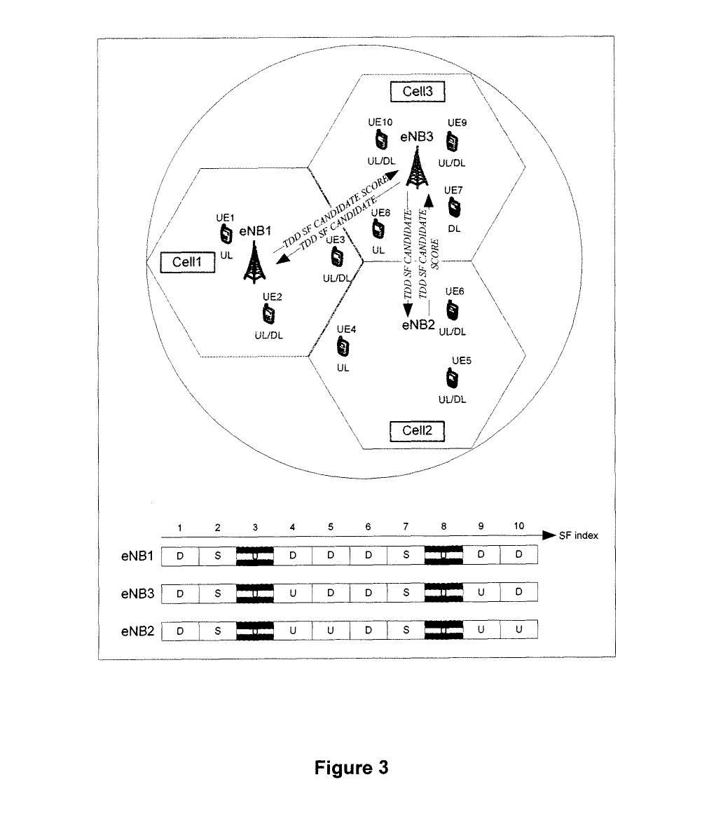

Consider for this example the radio environment of FIG. 3. There are three access nodes eNB1, eNB2 and eNB3 each having a plurality of UEs which they respectively serve: eNB1 is the serving cell for UE1, UE2 and UE3; eNB2 is the serving cell for UE4, UE5 and UE6; and eNB3 is the serving cell for UE7, UE8, UE9 and UE10. As an initial condition, at time T1 assume eNB1, eNB2 and eNB3 are using TDD configuration 2, TDD configuration 0 and TDD configuration 0 respectively.

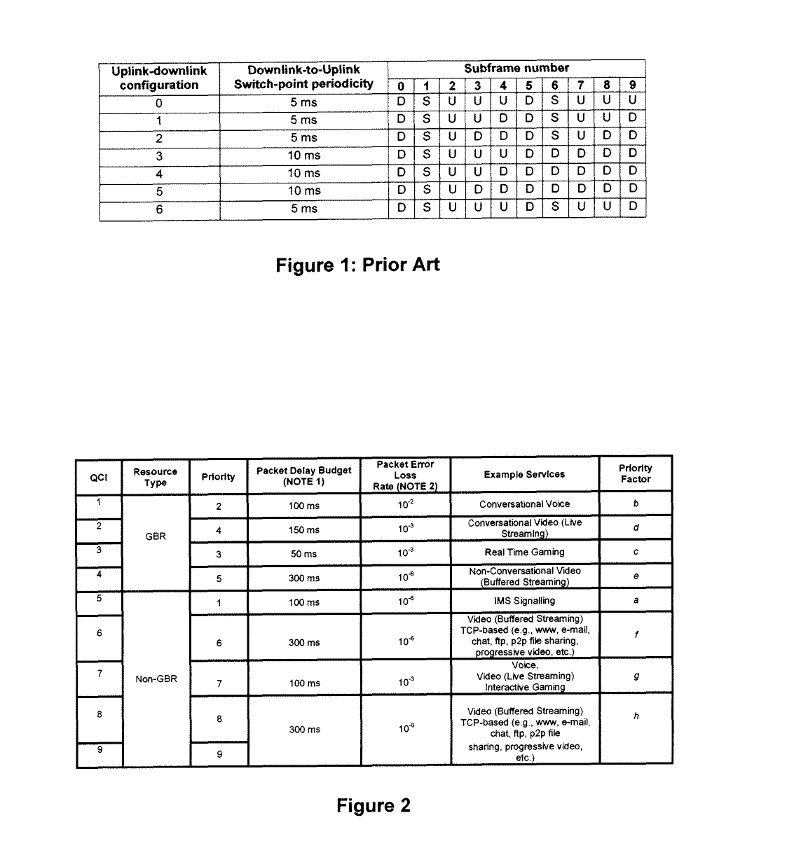

Then at time T2 in eNB3, UE7 has 2000 bits UL file transfer protocol FTP uploading traffic with weighting/priority factor of d=3; UE8 has 3000 bits DL real time gaming with weighting/priority factor of c=10 and 1000 bits UL real time gaming with weighting/priority factor of c=10; and UE9 has 1000 bits of conversational video traffic with weighting/priority factor of f=6. The above quantization assigns a value to the letter designators taken from the rightmost Priority Factor column of FIG. 2. In this example UE10 has no UL or DL data buffered and so does not influence the configuration decision. The total UL to DL ratio of traffic volume weighted for the different traffic type QCI using the equation above is then (2000*3+1000*10+1000*6)/(3000*10+2000*6)=11/21=0.52. The best fit TDD configurations from the A=7 options shown at FIG. 1, assuming the special subframes S are DL subframes, are then TDD configuration 1 (UL:DL=4:6=0.67) and TDD configuration 3 (UL:DL=3:7=0.43), so those will be chosen by the eNB3 as the configuration candidates.

Extending this example to the first embodiment above concerning the concentric mechanism, configuration #3 is the one which maximizes the overall DL and UL transmission opportunities and so that is the configuration which eNB3 selects for use in its cell. eNB1 will then inform eNB2 and eNB3, which by FIG. 3 are neighbor cells, of its decision.

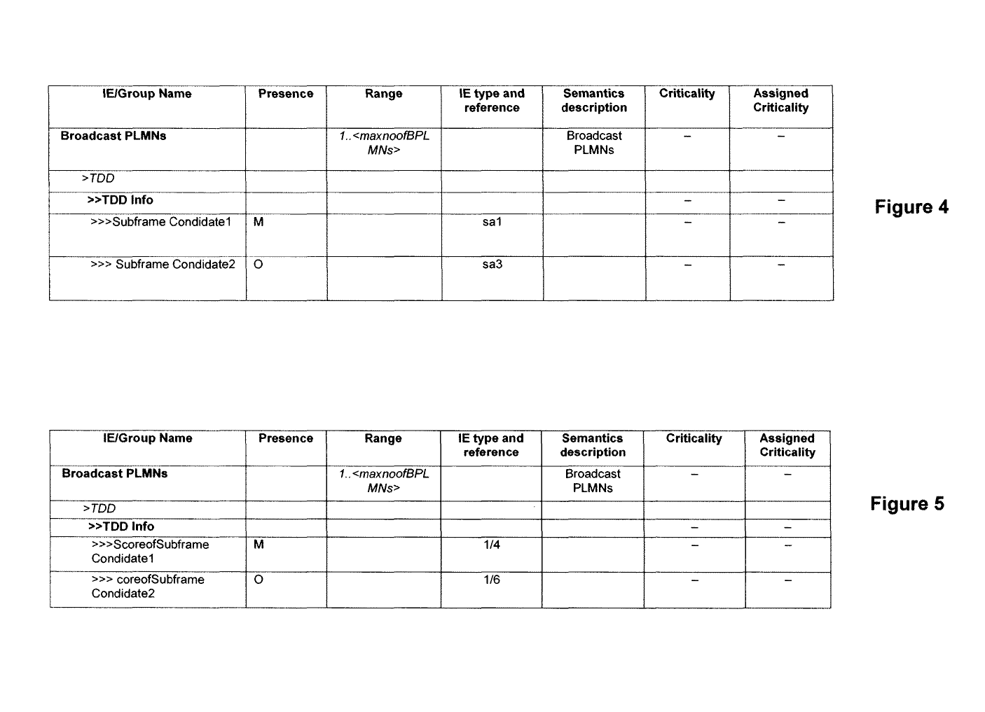

Extending this example now to the second embodiment above concerning neighbor cell polling, eNB3 will compute the weighted traffic ratio as above and select a few best-fit candidates which in this case are TDD configurations 1 and 3. eNB3 then sends this list of downlink-uplink configuration candidates to eNB1 and eNB2. In a specific embodiment eNB3 sends this information in a new information element such as that shown at FIG. 4 which is entitled IE TDD SF CANDIDATE. In the FIG. 4 example, the Subframe Condidate1 is subframe configuration #1, and the Subframe Condidate2 is subframe configuration #3. After receiving TDD SF CANDIDATE from eNB3, eNB1 and eNB2 will calculate a TDD SF CANDIDATE SCORE table which contains scores for each candidate TDD subframe configuration according to some rule, an example of which is shown at FIG. 5. In this example, the neighbor access node eNB1 sets the ScoreofSubframeCandidate1 to ¼ and the ScoreofSubframeCandidate2 to ⅙ after considering some rules such as overlapped UL and DL subframes, coverage of each cell, load status, traffic type and scheduling metrics, and so on. The other neighbor access node eNB2 in this example also sets a similar (or the same) TDD SF CANDIDATE SCORE.

After receiving the information element TDD SF CANDIDATE SCORE from both neighbor cells eNB1 and eNB2, the requesting cell eNB3 will calculate a combined score for each candidate TDD SF configuration which it originally provided to its neighbors. In this example, the score for SubframeCondidate1 is ¼+¼=½ and the score for SubframeCondidate2 is ⅙+⅙=⅓. So eNB3 will choose subframe configuration #1 and tell eNB1 and eNB2 its decision.

To summarize a few of the main advantages of the embodiments detailed above, the procedure which aims to decide the DL/UL subframe configuration and scheduling on a dynamic basis, and to reduce DL-UL interference, can increase efficiency in the cell so long as control signaling overhead is not too high, and the above examples limit that overhead. The new priority factor for the different traffic types, based on the QCI of different traffic, aids the eNB in deciding the DL/UL ratio. Additionally, there is presented in certain embodiments above a new rule that cell-edge UEs are preferred to be scheduled in fixed sub-frames, in order to avoid DL-UL interference in case of non-isolated cells. Similarly the cell-center UEs are preferred to be scheduled in flexible subframes since interference is a lesser concern. In one implementation above there is a new rule for deciding the TDD configuration to use in a cell, that is to minimize the number of overlapped UL and DL subframes with the neighboring cell or cells as the case may be. And finally in the second embodiment there is a new polling algorithm and mechanism, with corresponding signaling using new information elements such as those at FIGS. 4 and 5, to let neighbor eNBs know the chosen best-fit configuration candidates and for the neighbor eNBs to provide to the requesting eNB their own score table of those candidate TDD subframe configurations.

Embodiments of the invention detailed above provide certain technical effects such as for example reducing the sudden inter-cell impacts and obtaining a possible over-all performance gain when the TDD configuration is being changed dynamically. Also, by considering QoS of different traffic (indirectly, via the QCI), the determination of the dynamic TDD configuration is more accurate. As noted above, another technical effect is that the cell edge UE(s) can be protected when there is UL-DL or DL-UL interference by the chosen TDD configuration and the corresponding scheduling metric.

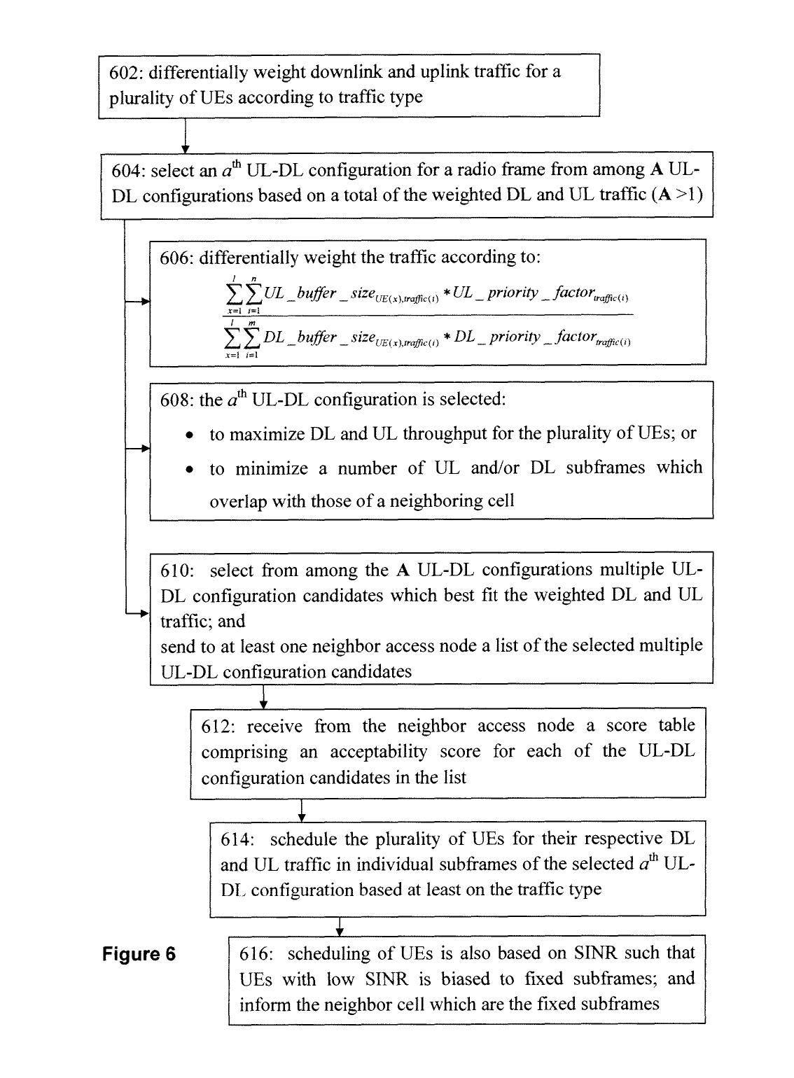

Since it is conventional that the UEs provide to the eNB in LTE their buffer status in order that the eNB can prioritize scheduling of those UEs with the largest data backlog, FIG. 6 presents actions taken and messages exchanged from the perspective of the eNB, specifically of eNB3 in the above examples. FIG. 6 is a logic flow diagram which summarizes the various exemplary embodiments of the invention from the perspective of that eNB (or other wireless network access node for non-LTE type systems), and may be considered to illustrate the operation of a method, and a result of execution of a computer program stored in a computer readable memory, and a specific manner in which components of an electronic device are configured to cause that electronic device to operate, whether such an electronic device is the access node in full or one or more components thereof such as a modem, chipset, or the like.

At block 602 the eNB differentially weights downlink and uplink traffic for a plurality of UEs according to traffic type. In the examples above the traffic class identifier QCI is used for traffic type, which also gives different priorities for the different traffic types. At block 604 then is selected an a^{th} uplink-downlink configuration for a radio frame from among A uplink-downlink configurations, and that selection is based on a total of the weighted downlink and uplink traffic. In this nomenclature the a^{th} uplink-downlink configuration is one from the total of the A possibilities, where A is an integer greater than one (A=seven in the FIG. 1 example).

Further portions of FIG. 6 details certain of the above non-limiting embodiments that further expand on blocks 602 and 604. Block 606 has the specific algorithm presented above for differentially weighting the downlink and uplink traffic, namely:

$$\frac{{\sum }_{x = 1}^{l} {\sum }_{i = 1}^{n} UL\_buffer {\_size}_{UE ( x ) , traffic ( i )} * UL\_priority {\_factor}_{traffic ( i )}}{\underline{{\sum }_{x = 1}^{l} {\sum }_{i = 1}^{m} DL\_buffer {\_size}_{UE ( x ) , traffic ( i )} * DL\_priority {\_factor}_{traffic ( i )}}} .$$

Block 608 summarizes the first embodiment above, in which the a^{th} UL-DL configuration is selected to maximize downlink and uplink throughput for the plurality of UEs; or alternatively it is selected to minimize a number of UL and/or DL subframes which overlap with those of a neighboring cell.

Block 610 summarizes the second embodiment above, where there is selected from among the A UL-DL configurations multiple UL-DL configuration candidates which best fit the weighted DL and UL traffic; and then the eNB sends to at least one neighbor access node a list of the selected multiple UL-DL configuration candidates. Block 612 further follows in that, in response to the sending at block 610, block 612 further has the eNB receiving from the at least one neighbor access node a score table comprising an acceptability score for each of the UL-DL configuration candidates in the list. In this case the a^{th} UL-DL configuration is selected from among the multiple UL-DL configuration candidates using the received score table. Following block 612 is block 614 which provides that scheduling the plurality of UEs for their respective DL and UL traffic in individual subframes of the selected a^{th} UL-DL configuration based at least on the traffic type. And further in this same chain for the second embodiment, block 616 provides that scheduling the plurality of UEs is further based at least on SINR of the respective UE such that scheduling of UEs with a relatively low SINR is biased to fixed subframes of the radio frame for which the a^{th} configuration is to be applied; and then the eNB informs the at least one neighbor cell which are the fixed subframes.

The various blocks shown in FIG. 6 may also be considered as a plurality of coupled logic circuit elements constructed to carry out the associated function(s), or specific result of strings of computer program code or instructions stored in a memory. Such blocks and the functions they represent are non-limiting examples, and may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

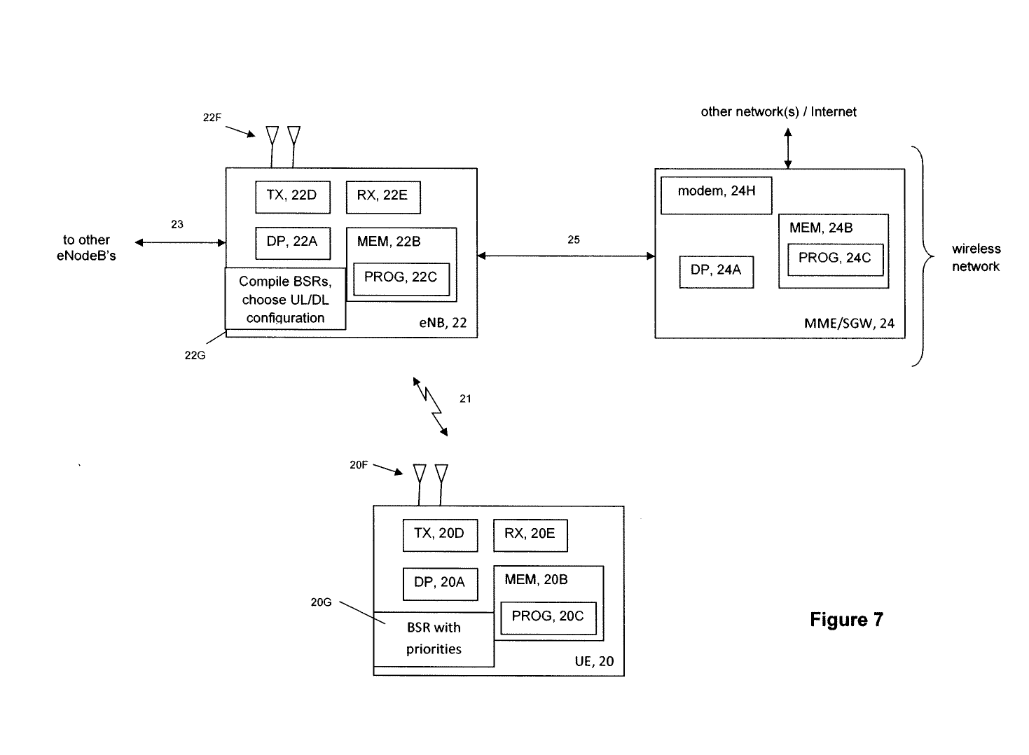

Reference is now made to FIG. 7 for illustrating a simplified block diagram of various electronic devices and apparatus that are suitable for use in practicing the exemplary embodiments of this invention. In FIG. 7 an eNB 22 is adapted for communication over a wireless link 21 with an apparatus, such as a mobile terminal or UE 20. While there are typically several UEs under control of the eNB 22 as shown at FIG. 3, for simplicity only one UE 20 is shown at FIG. 7. The eNB 22 may be any access node (including frequency selective repeaters) of any wireless network such as LTE, LTE-A, GSM, GERAN, WCDMA, and the like. The operator network of which the eNB 22 is a part may also include a network control element such as a mobility management entity MME and/or serving gateway SOW 24 or radio network controller RNC which provides connectivity with further networks (e.g., a publicly switched telephone network and/or a data communications network/Internet).

The UE 20 includes processing means such as at least one data processor (DP) 20A, storing means such as at least one computer-readable memory (MEM) 20B storing at least one computer program (PROG) 20C or other set of executable instructions, communicating means such as a transmitter TX 20D and a receiver RX 20E for bidirectional wireless communications with the eNB 22 via one or more antennas 20F. Also stored in the MEM 20B at reference number 200 is the UE's buffer status report BSR with its UL buffer volume information and the priorities for that buffered UL data. As noted above the eNB 22 has DL buffers for each UE and so already knows the DL traffic waiting to be sent to the various UEs and the priority of that traffic.

The eNB 22 also includes processing means such as at least one data processor (DP) 22A, storing means such as at least one computer-readable memory (MEM) 22B storing at least one computer program (PROG) 22C or other set of executable instructions, and communicating means such as a transmitter TX 22D and a receiver RX 22E for bidirectional wireless communications with the UE 20 (or UEs) via one or more antennas 22F. The eNB 22 stores at block 22G the rules/algorithm for compiling the UL and DL buffer volumes and for weighting according to the traffic type/priority/QCI, and for selecting one UL-DL configuration for a next radio frame using the various embodiments detailed more particularly above.

While not particularly illustrated for the UE 20 or eNB 22, those devices are also assumed to include as part of their wireless communicating means a modem and/or a chipset which may or may not be inbuilt onto an RF front end chip within those devices 20, 22 and which at least for the eNB 22 also operates to weight the UL and DL traffic according to class/priority/QCI and select a dynamic UL-DL configuration based on the weighted traffic profile according to these teachings.

At least one of the PROGs 22C in the eNB 22 is assumed to include a set of program instructions that, when executed by the associated DP 22A, enable the device to operate in accordance with the exemplary embodiments of this invention, as detailed above. The UE 20 may also have software stored in its MEM 20B to implement certain aspects of these teachings. In these regards the exemplary embodiments of this invention may be implemented at least in part by computer software stored on the MEM 20B, 22B which is executable by the DP 20A of the UE 20 and/or by the DP 22A of the eNodeB 22, or by hardware, or by a combination of tangibly stored software and hardware (and tangibly stored firmware). Electronic devices implementing these aspects of the invention need not be the entire devices as depicted at FIG. 7 or may be one or more components of same such as the above described tangibly stored software, hardware, firmware and DP, or a system on a chip SOC or an application specific integrated circuit ASIC.

In general, the various embodiments of the UE 20 can include, but are not limited to personal portable digital devices having wireless communication capabilities, including but not limited to cellular telephones, navigation devices, laptop/palmtop/tablet computers, digital cameras and music devices, and Internet appliances.

Various embodiments of the computer readable MEMs 20B, 22B include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the DPs 20A, 22A include but are not limited to general purpose computers, special purpose computers, microprocessors, digital signal processors (DSPs) and multi-core processors.

Various modifications and adaptations to the foregoing exemplary embodiments of this invention may become apparent to those skilled in the relevant arts in view of the foregoing description. While the exemplary embodiments have been described above in the context of the LTE and LTE-A system, as noted above the exemplary embodiments of this invention may be used with various other types of wireless communication systems.

Further, some of the various features of the above non-limiting embodiments may be used to advantage without the corresponding use of other described features. The foregoing description should therefore be considered as merely illustrative of the principles, teachings and exemplary embodiments of this invention, and not in limitation thereof.

1. An apparatus comprising
at least one processor; and
at least one memory including computer program code;
in which the at least one memory and the computer program code is configured, with the at least one processor, to cause the apparatus at least to:
differentially weight downlink and uplink traffic for a plurality of user equipments according to traffic type; and
select an a^{th} uplink-downlink configuration for a radio frame from among A uplink-downlink configurations based on a total of the weighted downlink and uplink traffic, in which A is an integer greater than one.

2. The apparatus according to claim 1, in which the downlink and uplink traffic is differentially weighted according to:
$$\frac{{\sum }_{x = 1}^{l} {\sum }_{i = 1}^{n} UL\_buffer {\_size}_{UE ( x ) , traffic ( i )} * UL\_priority {\_factor}_{traffic ( i )}}{\underline{{\sum }_{x = 1}^{l} {\sum }_{i = 1}^{m} DL\_buffer {\_size}_{UE ( x ) , traffic ( i )} * DL\_priority {\_factor}_{traffic ( i )}}}$$
in which
n is total number of uplink UL traffic;
m is total number of downlink DL traffic;
l is total number of the plurality of user equipments UEs;
UL_buffer_size_{UE(x), traffic(i)} is a buffer size of UL traffic(i) of UE(x);
DL_buffer_size_{UE(x), traffic(i)} is a buffer size of DL traffic(i) of UE(x), where iε(l . . . n) and xε(1 . . . l); and
UL_priority_factor_{traffic(i)} is a priority factor of UL traffic(i) and DL_priority_factor_{traffic(i)} is a priority factor of DL traffic(i), where UL_priority_factor_{traffic(i)} and DL_priority_factor_{traffic(i)} E(a, b, c, d, e, f, g, h) and the priority factor corresponds to the traffic type.

3. The apparatus according to claim 2, in which the priority factor is a traffic class identifier QCI.

4. The apparatus according to claim 1, in which the a^{th} uplink-downlink configuration is selected to:
maximize downlink and uplink throughput for the plurality of user equipments; or
minimize a number of uplink and/or downlink subframes which overlap with those of a neighboring cell.

5. The apparatus according to claim 1, in which the at least one memory and the computer program code is configured with the at least one processor, to cause the apparatus to further at least:
select from among the A uplink-downlink configurations multiple uplink-downlink configuration candidates which best fit the weighted downlink and uplink traffic; and
send to at least one neighbor access node a list of the selected multiple uplink-downlink configuration candidates.

6. The apparatus according to claim 5, in which the at least one memory and the computer program code is configured with the at least one processor, to cause the apparatus to further at least:
in response to sending the list of the selected multiple uplink-downlink configuration candidates, receive from the at least one neighbor access node a score table comprising an acceptability score for each of the uplink-downlink configuration candidates in the list;
wherein the a^{th} uplink-downlink configuration is selected from among the multiple uplink-downlink configuration candidates using the received score table.

7. The apparatus according to claim 6, in which the at least one memory and the computer program code is configured with the at least one processor to cause the apparatus to further at least:
schedule the plurality of user equipments for their respective downlink and uplink traffic in individual subframes of the selected a^{th} uplink-downlink configuration based at least on the traffic type.

8. The apparatus according to claim 7, in which the plurality of user equipments are scheduled based at least on signal to noise plus interference ratio of the respective user equipment such that scheduling of user equipments with a relatively low signal to noise plus interference ratio is biased to fixed subframes of the radio frame;
in which the at least one memory and the computer program code is configured with the at least one processor to cause the apparatus to further at least inform the at least one neighbor cell which are the fixed subframes.

9. The apparatus according claim 1, in which the apparatus comprises an eNB operating in an E-UTRAN radio system.

10. A method, comprising:
differentially weighting downlink and uplink traffic for a plurality of user equipments according to traffic type; and
selecting an a^{th} uplink-downlink configuration for a radio frame from among A uplink-downlink configurations based on a total of the weighted downlink and uplink traffic, in which A is an integer greater than one.

11. The method according to claim 10, in which the downlink and uplink traffic is differentially weighted according to:
$$\frac{{\sum }_{x = 1}^{l} {\sum }_{i = 1}^{n} UL\_buffer {\_size}_{UE ( x ) , traffic ( i )} * UL\_priority {\_factor}_{traffic ( i )}}{\underline{{\sum }_{x = 1}^{l} {\sum }_{i = 1}^{m} DL\_buffer {\_size}_{UE ( x ) , traffic ( i )} * DL\_priority {\_factor}_{traffic ( i )}}}$$
in which
n is total number of uplink UL traffic;
m is total number of downlink DL traffic;
l is total number of the plurality of user equipments UEs;
UL_buffer_size_{UE(x), traffic(i)} is a buffer size of UL traffic(i) of UE(x);
DL_buffer_size_{UE(x), traffic(i)} is a buffer size of DL traffic(i) of UE(x), where iε(l . . . n) and xε(1 . . . l); and
UL_priority_factor_{traffic(i)} is a priority factor of UL traffic(i) and DL_priority_factor_{traffic(i)} is a priority factor of DL traffic(i), where UL_priority_factor_{traffic(i)} and DL_priority_factor_{traffic(i)} E(a, b, c, d, e, f, g, h) and the priority factor corresponds to the traffic type.

12. The method according to claim 11, in which the priority factor is a traffic class identifier QCI.

13. The method according to claim 10, in which the a^{th} uplink-downlink configuration is selected to:
maximize downlink and uplink throughput for the plurality of user equipments; or
minimize a number of uplink and/or downlink subframes which overlap with those of a neighboring cell.

14. The method according to claim 10, the method further comprising:
selecting from among the A uplink-downlink configurations multiple uplink-downlink configuration candidates which best fit the weighted downlink and uplink traffic; and
sending to at least one neighbor access node a list of the selected multiple uplink-downlink configuration candidates.

15. The method according to claim 14, the method further comprising:
in response to sending the list of the selected multiple uplink-downlink configuration candidates, receiving from the at least one neighbor access node a score table comprising an acceptability score for each of the uplink-downlink configuration candidates in the list;
wherein the a^{th} uplink-downlink configuration is selected from among the multiple uplink-downlink configuration candidates using the received score table.

16. The method according to claim 15, the method further comprising:
scheduling the plurality of user equipments for their respective downlink and uplink traffic in individual subframes of the selected a^{th} uplink-downlink configuration based at least on the traffic type.

17. The method according to claim 16, in which scheduling the plurality of user equipments is further based at least on signal to noise plus interference ratio of the respective user equipment such that scheduling of user equipments with a relatively low signal to noise plus interference ratio is biased to fixed subframes of the radio frame;
and in which the method further comprises informing the at least one neighbor cell which are the fixed subframes.

18. A memory tangibly storing a computer program that is executable by at least one processor, in which the computer program comprises:
code for differentially weighting downlink and uplink traffic for a plurality of user equipments according to traffic type; and
code for selecting an a^{th} uplink-downlink configuration for a radio frame from among A uplink-downlink configurations based on a total of the weighted downlink and uplink traffic, in which A is an integer greater than one.

19. The memory according to claim 18, in which the downlink and uplink traffic is differentially weighted according to:
$$\frac{{\sum }_{x = 1}^{l} {\sum }_{i = 1}^{n} UL\_buffer {\_size}_{UE ( x ) , traffic ( i )} * UL\_priority {\_factor}_{traffic ( i )}}{\underline{{\sum }_{x = 1}^{l} {\sum }_{i = 1}^{m} DL\_buffer {\_size}_{UE ( x ) , traffic ( i )} * DL\_priority {\_factor}_{traffic ( i )}}}$$
in which
n is total number of uplink UL traffic;
m is total number of downlink DL traffic;
l is total number of the plurality of user equipments UEs;
UL_buffer_size_{UE(x), traffic(i)} is a buffer size of UL traffic(i) of UE(x);
DL_buffer_size_{UE(x), traffic(i)} is a buffer size of DL traffic(i) of UE(x), where iε(l . . . n) and xε(1 . . . l); and
UL_priority_factor_{traffic(i)} is a priority factor of UL traffic(i) and DL_priority_factor_{traffic(i)} is a priority factor of DL traffic(i), where UL_priority_factor_{traffic(i)} and DL_priority_factor_{traffic(i)} E(a, b, c, d, e, f, g, h) and the priority factor corresponds to the traffic type.

20. The memory according to claim 18, in which the computer program further comprises:
code for selecting from among the A uplink-downlink configurations multiple uplink-downlink configuration candidates which best fit the weighted downlink and uplink traffic;
code for sending to at least one neighbor access node a list of the selected multiple uplink-downlink configuration candidates; and
code for receiving from the at least one neighbor access node, in response to sending the list of the selected multiple uplink-downlink configuration candidates, a score table comprising an acceptability score for each of the uplink-downlink configuration candidates in the list;
wherein the code for selecting the a^{th} uplink-downlink configuration operates to select from among the multiple uplink-downlink configuration candidates using the received score table.
